(19) United States
(12) Patent Application Publication
(10) Pub. No.: US 2008/0272688 A1
(43) Pub. Date: Nov. 6, 2008

(54) Phosphor and Method of preparing the same as well as semiconductor light-emitting device and image display

(75) Inventor: Kenichi Yoshimura, Tenri-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/976,418

(22) Filed: Oct. 24, 2007

(30) Foreign Application Priority Data
Nov. 14, 2006 (JP) 2006-307875(P)

(51) Int. Cl. H01J 1/62; C09K 11/77; C09K 11/59

(52) U.S. Cl. 313/503; 252/301.4 F

(57) ABSTRACT

A β-sialon phosphor containing an optical active element M, having a specific surface area of not more than 0.8 m²/g measured by the air permeation method, and a method of preparing a β-sialon phosphor including a firing step of firing a mixture containing metallic compound powder in which the mixture contains (A) metallic compound powder containing the optical active element M and (B) metallic compound powder coated with a specific coating compound are provided. A β-sialon phosphor having high homogeneity of crystals with high luminous efficiency resulting from suppression of a different phase can be obtained. This phosphor is preferably applied to a semiconductor light-emitting device and an image display.

This nonprovisional application is based on Japanese Patent Application No. 2006-307875 filed with the Japan Patent Office on Nov. 14, 2006, the entire contents of which are hereby incorporated by reference.

### BACKGROUND OF THE INVENTION

1. Field of the Invention

The present invention relates to a phosphor and a method of preparing the same, as well as a semiconductor light-emitting device and an image display employing this phosphor.

2. Description of the Background Art

A light-emitting device obtained by combining a light-emitting element emitting primary light and a wavelength conversion portion absorbing the primary light and emitting secondary light is noted as an advanced light-emitting device to which low power consumption, downsizing, high brightness and wide-ranging color reproducibility are expectable, and subjected to active research and development. In general, the primary light emitted from the light-emitting element is in the long-wave ultraviolet to blue light range. The wavelength conversion portion is generally formed by a phosphor such as that of an oxide, for example.

Under such circumstances, nitride and oxynitride phosphors, having strong absorption in the near ultraviolet to visible light range, thermally and chemically stabler than the conventional phosphors and preferably excitable by a semiconductor light-emitting element of GaN or the like have recently been proposed. Among such nitride and oxynitride phosphors, a β-sialon phosphor disclosed in Japanese Patent Laying-Open No. 2005-255895, exhibiting a sharp emission spectrum having a peak wavelength in the range of 500 nm to 550 nm and assuming (x, y) values of 0≦x≦0.3 and 0.6≦y≦0.83 on the CIE coordinates, is preferably employed for a display device such as a liquid crystal display (hereinafter abbreviated as LCD) in particular.

Japanese Patent Laying-Open No. 2005-255895 discloses a method of improving reactivity in firing by adding a fluoride, a chloride, an iodide, a bromide or a phosphate of an element selected from Li, Na, K, Mg, Ca, Sr and Ba forming a liquid phase at a temperature not more than the firing temperature to a mixture of Si₃N₄ and metallic compounds of AlN and Eu₂O₃, as a countermeasure for improving luminous efficiency of the β-sialon phosphor. The reactivity in firing is so improved as to prompt growth of crystal grains, thereby improving the luminous efficiency of the obtained phosphor.

In the aforementioned method, however, the mixture contains a metallic element, other than those for forming β-sialon, derived from the inorganic additive at the time of firing, leading to such problems that a different phase such as Ca-α-sialon shown in Japanese Patent Laying-Open No. 2002-363554, for example, is easily formed and the metallic element other than those for forming β-sialon is incorporated into the crystals of the β-sialon phosphor to reduce homogeneity of the crystals or to inhibit crystal growth of β-sialon. Consequently, brightness of the β-sialon phosphor cannot be sufficiently improved. Particularly when the inorganic additive contains an alkaline earth metal such as Ca or Mg, α-sialon crystals are easily formed.

The present invention has been proposed in order to solve the aforementioned problem, and an object of the present invention is to provide a β-sialon phosphor, having high homogeneity of crystals with high luminous efficiency resulting from suppression of a different phase, preferably employable for an image display such as an LCD backlight and a method of preparing the same. Another object of the present invention is to provide a semiconductor light-emitting device and an image display employing this phosphor.

### SUMMARY OF THE INVENTION

The inventors have made deep studies in order to solve the aforementioned problem, to find that a β-sialon phosphor having a small specific surface area of not more than 0.8 m²/g measured by the air permeation method, in which the ratio occupied by a β phase in the crystal phase is preferably at least 70 weight % and the content of a metallic element other than an optical active element M, Si and Al is not more than 100 ppm in weight ratio has higher luminous intensity as compared with conventional phosphors. They have also found that a β-sialon phosphor having a small specific surface area, low content of different phases and high luminous intensity is obtained by employing metallic compound powder whose surface is coated with a compound, forming a liquid phase at a temperature lower than a firing temperature, containing at least one element selected from Si and Ai as one of raw materials for the phosphor. In other words, the present invention is as follows:

The present invention provides a β-sialon phosphor containing an optical active element M, having a specific surface area of not more than 0.8 m²/g, more preferably not more than 0.4 m²/g, measured by the air permeation method.

In the β-sialon phosphor according to the present invention, the ratio occupied by a β phase in the crystal phase is preferably at least 70 weight %, more preferably at least 90 weight %, and the content of a metallic element other than the optical active element M, Si and Al is not more than 100 ppm in weight ratio.

The present invention also provides a method of preparing a β-sialon phosphor containing an optical active element M, including a firing step of firing a mixture containing metallic compound powder, in which the mixture contains (A) metallic compound powder containing the optical active element M and (B) metallic compound powder coated with a compound, forming a liquid phase at a temperature lower than a firing temperature, containing at least one element selected from Si and Al.

The mixture may further contain (C) at least one material selected from metallic compound powder consisting of Si₃N₄ and metallic compound powder consisting of AlN.

The aforementioned metallic compound powder in (B) is preferably at least one material selected from metallic compound powder consisting of Si₃N₄ and metallic compound powder consisting of AlN.

The optical active element M is preferably at least one element selected from a group consisting of Mn, Ce, Pr, Nd, Sm, Eu, Tb, Dy, Ho, Er, Tm and Yb, more preferably Eu.

The aforementioned compound, forming a liquid phase at a temperature lower than the firing temperature, containing at least one element selected from Si and Al is preferably an oxide, more preferably SiO₂.

In the firing step, the mixture containing the metallic compound powder is preferably shaped into granules consisting of aggregates of the powder, and the granules are preferably thereafter fired. The granules are preferably shaped by spray-drying a slurry containing the mixture containing the metallic compound powder and a solvent.

The method of preparing a β-sialon phosphor according to the present invention may have a coating step of preparing (B) the metallic compound powder coated with a compound, forming a liquid phase at a temperature lower than the firing temperature, containing at least one element selected from Si and Al, in advance of the firing step.

This coating step preferably includes a spray-drying step of spray-drying a slurry containing the metallic compound powder to be coated, the compound, forming a liquid phase at a temperature lower than the firing temperature, containing at least one element selected from Si and Al and a solvent. The present invention further provides a β-sialon phosphor containing the optical active element M, prepared by the aforementioned method.

The present invention further provides a semiconductor light-emitting device at least having a semiconductor light-emitting element and a phosphor excited by light emitted from the semiconductor light-emitting element, in which at least one phosphor is the aforementioned β-sialon phosphor. The semiconductor light-emitting element according to the present invention preferably has an InGaN layer as an active layer.

The semiconductor light-emitting device according to the present invention at least has the semiconductor light-emitting element and the phosphor excited by light emitted from the light-emitting element, while the semiconductor light-emitting element preferably has a peak emission wavelength in the range of 350 to 430 nm, and the phosphor preferably at least contains the aforementioned β-sialon phosphor according to the present invention. The phosphor particularly preferably further contains at least one selected from a La₃Si₈N₁₁O₄ phosphor or solid solution such as a Ce-activated La₃Si₈N₁₁O₄ phosphor and a CaAlSiN₃ phosphor such as an Eu-activated CaAlSiN₃ phosphor.

The semiconductor light-emitting device according to the present invention at least has the semiconductor light-emitting element and the phosphor excited by light emitted from the light-emitting element, while the semiconductor light-emitting element preferably has a peak emission wavelength in the range of 430 to 480 nm, and the phosphor preferably at least contains the aforementioned β-sialon phosphor according to the present invention. The phosphor particularly preferably further contains a CaAlSiN₃ phosphor such as an Eu-activated CaAlSiN₃ phosphor.

The present invention further provides an image display employing the aforementioned semiconductor light-emitting device. This image display is preferably a liquid crystal display (LCD) employing the semiconductor light-emitting device as a backlight source.

The β-sialon phosphor according to the present invention, having high homogeneity of crystals, preferably having low content of different phases as compared with the conventional phosphors with the ratio of at least 70 weight % occupied by the β phase in the crystal phase and exhibiting the low content of not more than 100 ppm of the metallic element other than those forming the phosphor, has higher luminous efficiency as compared with the conventional phosphors. According to the inventive method of preparing a β-sialon phosphor, a β-sialon phosphor having high homogeneity of crystals and low content of different phases and metallic elements other than those forming the phosphor is obtained due to improvement in reactivity in firing and promotion of crystal growth. Further, a β-sialon phosphor having higher luminous efficiency than the conventional phosphors is obtained due to the promotion of crystal growth, improvement in the homogeneity of crystals and low content of different phases and the metallic elements other than those forming the phosphor. The β-sialon phosphor according to the present invention is preferably employable for a semiconductor light-emitting device, an image display and the like.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic sectional view showing a semiconductor light-emitting device according to a preferred embodiment of the present invention;

FIG. 2A shows the absorption (excitation) spectra of phosphor powder materials obtained according to Examples 1 to 3, and FIG. 2B shows the emission spectra of the phosphor powder materials obtained according to Examples 1 to 3;

FIG. 3A shows the absorption (excitation) spectra of the phosphor powder materials obtained according to Examples 1 to 3 and those of phosphor powder materials obtained according to comparative examples 1 and 2 in comparison with each other, and FIG. 3B shows the emission spectra of the phosphor powder materials obtained according to Examples 1 to 3 and those of the phosphor powder materials obtained according to comparative examples 1 and 2 in comparison with each other;

FIG. 4 is an SEM photograph showing granules formed in Example 2 in 1000 magnifications;

FIG. 5 is a schematic diagram showing an exemplary image display according to the present invention; and

FIG. 6 is a schematic diagram showing another exemplary image display according to the present invention.

### DESCRIPTION OF THE PREFERRED EMBODIMENTS

### <β-Sialon Phosphor>

The β-sialon phosphor according to the present invention contains the optical active element M, and the specific surface area measured by the air permeation method is not more than 0.8 m²/g. The specific surface area is preferably not more than 0.4 m²/g. The luminous efficiency can be more improved by setting the specific surface area to not more than 0.8 m²/g. In other words, the small specific surface area indicates that individual particles constituting the phosphor have large diameters and the phosphor has high crystal homogeneity. In general, a phosphor having high crystal homogeneity exhibits high luminous efficiency. The term “air permeation method” denotes the method generally referred to as “Lea-Nurse method”, and the specific surface area can be obtained by measuring the flow velocity of and a pressure drop in air permeating a layer packed with a sample.

The ratio occupied by the β phase in the crystal phase is preferably at least 70 weight %, more preferably at least 90 weight %. The luminous intensity can be more increased due to this property. If phases such as a glassy phase, an α phase etc. other than the β phase are mixed into the crystals and the ratio occupied by the β phase is reduced to less than 70 weight %, for example, absorption irrelevant to fluorescence is so increased that the luminous intensity of the phosphor is reduced.

While the β-sialon phosphor generally contains the optical active element M such as Mn, Ce, Pr, Nd, Sm, Eu, Tb, Dy, Ho, Er, Tm or Yb and this optical active element M emits fluorescence, such a problem arises that homogeneity of the obtained crystals is deteriorated if the phosphor further contains a metallic element other than Si, Al and M constituting the β-sialon phosphor, to result in reduction in fluorescence intensity. In the β-sialon phosphor according to the present invention, therefore, the content of a metallic element other than the optical active element M, Si and Al is preferably not more than 100 ppm, more preferably not more than 50 ppm in weight ratio.

The ratio occupied by the β phase in the crystal phase of the phosphor can be measured by a peak intensity ratio in X-ray diffraction measurement, for example.

The content of the metallic element other than the optical active element M, Si and Al can be measured by a CID-DCA emission spectrometer, for example.

### <Active Element>

At least one element selected from the group consisting of Mn, Ce, Pr, Nd, Sm, Eu, Tb, Dy, Ho, Er, Tm and Yb can be listed as the optical active element M. This element activates the host crystals, thereby acting as the emission center, for developing fluorescent characteristics. Among the aforementioned materials, Eu is preferably employed as the optical active element M.

While a method of preparing the aforementioned β-sialon phosphor is not particularly limited, the following method can be preferably employed:

### <Method of Preparing β-Sialon Phosphor>

The method of preparing a β-sialon phosphor according to the present invention has a firing step of firing a mixture containing at least two types of metallic compound powder materials. This mixture at least contains the following (A) and (B):

(A) metallic compound powder containing the optical active element M, and

(B) metallic compound powder coated with a compound (this compound may be hereinafter referred to also as “coating compound”), forming a liquid phase at a temperature lower than a firing temperature, containing at least one element selected from Si and Al.

According to the inventive method of preparing a β-sialon phosphor, a β-sialon phosphor having a specific surface area of not more than 0.8 m²/g measured by the air permeation method, in which the ratio occupied by a β phase in the crystal phase is preferably at least 70 weight % and the content of a metallic element other than an optical active element M, Si and Al is not more than 100 ppm in weight ratio can be obtained. In other words, (B) the metallic compound powder coated with the coating compound, the compound forming a liquid phase at a temperature lower than the firing temperature and containing at least one element selected from Si and Al is so employed as at least one of the metallic compound powder materials serving as the raw materials for the phosphor that an effect of improving the reactivity in firing is attained, while the compound forming a liquid phase at a temperature lower than the firing temperature so contains the metallic element Si or Al contained in β-sialon that formation of a different phase such as α-sialon is suppressed and the ratio of a metallic element, other than the optical active element M and the elements constituting the β-sialon phosphor, incorporated into the phosphor crystals can be reduced. According to the present invention, the surface of the metallic compound powder is so coated with the compound forming a liquid phase at a temperature lower than the firing temperature that the reactivity of a substance having lower reactivity can be selectively improved, and an effect of prompting crystal growth is more increased as compared with the aforementioned method disclosed in Japanese Patent Laying-Open No. 2005-255895.

Further, the surface of the metallic compound powder is so coated with the coating compound that an effect of suppressing reaction between oxygen, moisture etc. contained in atmosphere gas and the unfired metallic compound powder can also be attained.

The metallic compound powder in aforementioned (B) is preferably at least one material selected from metallic compound powder consisting of Si₃N₄ and metallic compound powder consisting of AlN, in order to form the β-sialon phosphor.

In particular, the metallic compound powder in aforementioned (B) is more preferably the metallic compound powder consisting of AlN. While AlN reacts with moisture and oxygen contained in the atmosphere and forms an oxide film layer on the surface, the oxide film layer is so hard to control that the same causes an unexpected composition shift in the fired phosphor. Further, Al₂O₃, which is an oxide of AlN, has a melting point of at least 2000° C. higher than the general firing temperature (about 1800° C. to 2000° C.) for the β-sialon phosphor, and may inhibit the reaction. When a highly reactive substance such as AlN is used as the metallic compound powder in aforementioned (B) employed as one of the raw materials for the phosphor, therefore, an effect of protecting the surface of the unfired metallic compound powder can also be expected, in addition to the effect of improving the reactivity in firing.

The aforementioned coating compound forms a liquid phase at a temperature lower than the firing temperature, and contains at least one element selected from Si and Al. The expression “forms a liquid phase at a temperature lower than the firing temperature” means that the coating compound is at least partially liquefied at this temperature. If a substance forming a liquid phase at a lower temperature than the remaining ones is present in the firing step, this substance prompts liquefaction of the remaining ones. Therefore, the coating compound must form a liquid phase at a temperature lower than the firing temperature. Since the firing temperature for the β-sialon phosphor is generally not more than 2000° C., the temperature at which the coating compound forms a liquid phase is preferably not more than 2000° C., more preferably not more than 1800° C.

The coating compound contains at least one element selected from Si and Al, in order to suppress formation of a different phase such as α-sialon and to introduce no metallic element other than those constituting the phosphor, as hereinabove described. This compound is so employed as to prompt crystal growth and improve crystal homogeneity, thereby reducing the specific surface area of the obtained phosphor as a result.

The coating compound is preferably formed by an oxide containing at least one element selected from Si and Al since such an oxide can be easily obtained with small particle diameters, the metallic compound powder can be easily coated with the oxide and the oxide has a low melting point, and SiO₂ can be preferably employed, for example. SiO₂ forms a liquid phase at a temperature of about 1700° C.

In the present invention, commercially available powder may be employed as the aforementioned metallic compound powder (B) whose surface is coated with the coating compound. Alternatively, the metallic compound powder (B) may be prepared by coating metallic compound powder with the coating compound by a method described later, for example. The coating of the metallic compound powder with the coating compound can be confirmed through an SEM image or by EDX (energy-dispersive X-ray spectroscopy) measurement, for example.

The aforementioned mixture of the metallic compound powder materials serving as the raw material for the phosphor contains (A) the metallic compound powder containing the optical active element M. The optical active element M forms the emission center of the phosphor. At least one element selected from the group consisting of Mn, Ce, Pr, Nd, Sm, Eu, Tb, Dy, Ho, Er, Tm and Yb can be listed as the optical active element M. This element activates the host crystals, thereby acting as the emission center, for developing fluorescent characteristics.

Among the aforementioned materials, Eu is preferably employed as the optical active element M, and Eu₂O₃, EuN or the like is preferably employed as (A) the metallic compound powder containing the optical active element M. A β-sialon phosphor activated by Eu is efficiently excited by light having a wavelength of at least 100 nm and not more than 500 nm, and emits green light. In particular, the Eu-activated β-sialon phosphor, efficiently excited by near ultraviolet to blue light in the range of 350 nm to 470 nm, can be preferably employed as a phosphor for a light source employing a semiconductor light-emitting element such as an LED as the excitation source.

The aforementioned mixture may further contain (C) at least one material selected from metallic compound powder consisting of Si₃N₄ and metallic compound powder consisting of AlN, in addition to the aforementioned materials (A) and (B). The material (C) is uncoated metallic compound powder, dissimilarly to the material (B). The mixture typically contains uncoated Si₃N₄ powder as the material (C) when containing coated AlN powder as the material (B). Alternatively, the mixture contains uncoated AlN powder as the material (C) when containing coated Si₃N₄ powder as the material (B). Further alternatively, the mixture may contain both of coated metallic compound powder (AlN powder and/or Si₃N₄ powder, for example) and uncoated metallic compound powder (AlN powder and/or Si₃N₄ powder, for example).

The inventive method of preparing a β-sialon phosphor employing the aforementioned mixture containing metallic compound powder materials is now specifically described. The method of preparing a β-sialon phosphor according to the present invention includes a firing step of firing the mixture containing the aforementioned materials (A) and (B), as well as the material (C) if necessary. The mixture is fired at a temperature of at least 1800° C., typically at least 1800° C. and less than 2000° C. The mixture is so fired at the temperature of at least 1800° C. that a phosphor exhibiting emission in high brightness is obtained. The mixing ratio between the metallic compound powder materials is properly selected in consideration of the composition ratio in the obtained phosphor.

The aforementioned firing step is preferably carried out by shaping the aforementioned mixture of the metallic compound powder materials into granules consisting of aggregates of the powder materials and thereafter firing the granules. Thus, the reactivity in firing is further increased, and the luminous efficiency of the phosphor is further improved.

The aforementioned granules are typically shaped by forming a slurry containing the mixture of the metallic compound powder materials and a solvent and spray-drying this slurry. The slurry is formed by homogeneously mixing the mixture of the metallic compound powder materials and the solvent with each other in a ball mill or the like.

While the solvent used for forming the slurry is not particularly restricted, water, methanol, ethanol, n-propanol, n-hexane, acetone, toluene or the like can be listed. The solvent is preferably selected from alcohols in consideration of dispersibility of the metallic compound powder materials, and is particularly preferably ethanol if silicon nitride and aluminum nitride are employed as the metallic compound powder materials, in consideration of reactivity with these materials and dispersibility into the solvent. A single such solvent may be employed, or two or more solvents may be employed in a mixed state.

A spray drier system of drying sprayed particles in a chamber with a circulating hot air current is preferably employed for spray-drying the aforementioned slurry, due to simple equipment and apparatus. For example, Mini Spray Drier B-290 by Nihon Buchi K.K. can be preferably employed as a granulator employing the spray drier system.

While the temperature for spray-drying the slurry is not particularly restricted, the slurry can be spray-dried at a temperature of 70° C. to 200° C., and is preferably spray-dried at a temperature of 100° C. to 200° C., in order to sufficiently evaporate the solvent.

The average particle diameter of the granules is preferably not more than 50 μm. Phosphor particles uniform in particle diameter can be obtained by setting the average particle diameter of the granules to not more than 50 μm. The average particle diameter of the granules can be confirmed through an SEM image.

A method of coating the surface of the metallic compound powder with the coating compound is now described. While the coating method is not particularly restricted, the aforementioned spray drying can be preferably employed due to the simplicity and uniform coating ability.

In other words, the surface of the metallic compound powder is coated with the coating compound by forming a slurry containing the metallic compound powder to be coated, the coating compound (such as SiO₂ powder) forming a liquid phase at a temperature lower than the firing temperature and containing at least one element selected from Si and Al and a solvent and spray-drying this slurry. The slurry is formed by homogeneously mixing these materials with each other in a ball mill or the like.

While the solvent used for forming the slurry is not particularly restricted, water, methanol, ethanol, n-propanol, n-hexane, acetone, toluene or the like can be listed. The solvent is preferably selected from alcohols in consideration of dispersibility of the metallic compound powder, and is particularly preferably ethanol if silicon nitride or aluminum nitride is employed as the metallic compound powder, in consideration of reactivity with this material and dispersibility into the solvent. A single such solvent may be employed, or two or more solvents may be employed in a mixed state.

A spray drier system of drying sprayed particles in a chamber with a circulating hot air current is preferably employed for spray-drying the aforementioned slurry, due to simple equipment and apparatus. For example, Mini Spray Drier B-290 by Nihon Buchi K.K. can be preferably employed as a granulator employing the spray drier system.

While the temperature for spray-drying the slurry is not particularly restricted, the slurry can be spray-dried at a temperature of 70° C. to 200° C., and is preferably spray-dried at a temperature of 100° C. to 200° C., in order to sufficiently evaporate the solvent.

The β-sialon phosphor obtained by firing the mixture containing the aforementioned metallic compound powder materials has a specific surface area of not more than 0.8 m²/g measured by the air permeation method, while the ratio occupied by a β phase in the crystal phase is preferably at least 70 weight %, and the content of a metallic element other than the optical active element M, Si and Al is preferably not more than 100 ppm in weight ratio. Comparing the β-sialon phosphor obtained by firing the mixture containing the coated metallic compound powder according to the inventive method with a β-sialon phosphor obtained by firing a mixture containing uncoated metallic compound powder, the former generally exhibits a specific surface area of not more than 80% of that of the latter.

### <Semiconductor Light-Emitting Device and Image Display>

The aforementioned phosphor according to the present invention can be preferably employed as a fluorescent material for a semiconductor light-emitting device. The present invention also provides a semiconductor light-emitting device at least having a semiconductor light-emitting element and a phosphor excited by light emitted from the semiconductor light-emitting element, in which at least one phosphor is the aforementioned phosphor according to the present invention. A general well-known structure can be employed for the semiconductor light-emitting device according to the present invention, except that the aforementioned phosphor according to the present invention is employed as a fluorescent material. The semiconductor light-emitting element preferably has an InGaN layer as an active layer.

FIG. 1 is a schematic sectional view showing a semiconductor light-emitting device according to a preferred embodiment of the present invention. In the semiconductor light-emitting device shown in FIG. 1, a semiconductor light-emitting element 102 is arranged on a printed wiring board 101 serving as a substrate. Semiconductor light-emitting element 102 preferably has an InGaN layer 103 as an active layer, as shown in FIG. 1. A resin frame 104 is filled up with molding resin 105 of optically transparent resin into which the phosphor according to the present invention is dispersed, for sealing semiconductor light-emitting element 102. In this resin frame 104, an electrode portion 106 arranged along the upper surface and the rear surface of printed wiring board 101 and an N-side electrode 107 of semiconductor light-emitting element 102 are electrically connected with each other by a conductive adhesive 111. On the other hand, a P-side electrode 108 of semiconductor light-emitting element 102 is electrically connected to another electrode portion 110 arranged along the upper surface and the rear surface of printed wiring board 101 by a metal wire 109.

The phosphor dispersed into molding resin 105 may be prepared solely from the β-sialon phosphor according to the present invention, or one or more other phosphors may be mixed into the phosphor according to the present invention. For example, an Eu-activated α-sialon phosphor, a Ce-activated β-sialon phosphor, a Ce-activated JEM phosphor, a Ce-activated La₃Si₈N₁₁O₄ phosphor, an Eu-activated CaAlSiN₃ phosphor and/or the like may be mixed with the β-sialon phosphor according to the present invention and dispersed into molding resin 105, for emitting white light by color mixture of the phosphors.

As a specific structure of the semiconductor light-emitting device according to the present invention, a structure at least containing the Eu-activated β-sialon phosphor according to the present invention as the phosphor can be listed, assuming that the semiconductor light-emitting element has a peak emission wavelength of 350 to 430 nm, for example. According to this structure, a semiconductor light-emitting device having excellent brightness and color reproducibility (NTSC ratio) can be provided. The light-emitting device preferably contains at least one of a Ce-activated La₃Si₈N₁₁O₄ phosphor or solid solution and an Eu-activated CaAlSiN₃ phosphor as the phosphor along with the aforementioned Eu-activated β-sialon phosphor, since the phosphor is efficiently excited by near ultraviolet light of 350 to 430 nm and has excellent wavelength matching with a color filter employed for a general LCD.

As another specific structure of the semiconductor light-emitting device according to the present invention, a structure at least containing the Eu-activated β-sialon phosphor according to the present invention as the phosphor can be listed, assuming that the semiconductor light-emitting element has a peak emission wavelength of 430 to 480 nm, for example. According to this structure, a semiconductor light-emitting device having excellent brightness and color reproducibility (NTSC ratio) can be provided. The light-emitting device preferably contains an Eu-activated CaAlSiN₃ phosphor as the phosphor along with the aforementioned Eu-activated β-sialon phosphor, since the phosphor is efficiently excited by visible light of 430 to 480 nm and has excellent wavelength matching with a color filter employed for a general LCD.

The semiconductor light-emitting device according to the present invention exhibits high luminous intensity, due to the aforementioned β-sialon phosphor according to the present invention employed as the fluorescent material.

The aforementioned semiconductor light-emitting device according to the present invention can be preferably employed for an image display. For example, the aforementioned semiconductor light-emitting device according to the present invention can be employed as a backlight source for an LCD. This image display is excellent in brightness and color reproducibility, due to the inventive phosphor carried thereon.

While the present invention is now described in more detail with reference to Examples, the present invention is not restricted to these Examples.

### EXAMPLES

### Preparation of Phosphor

### Example 1

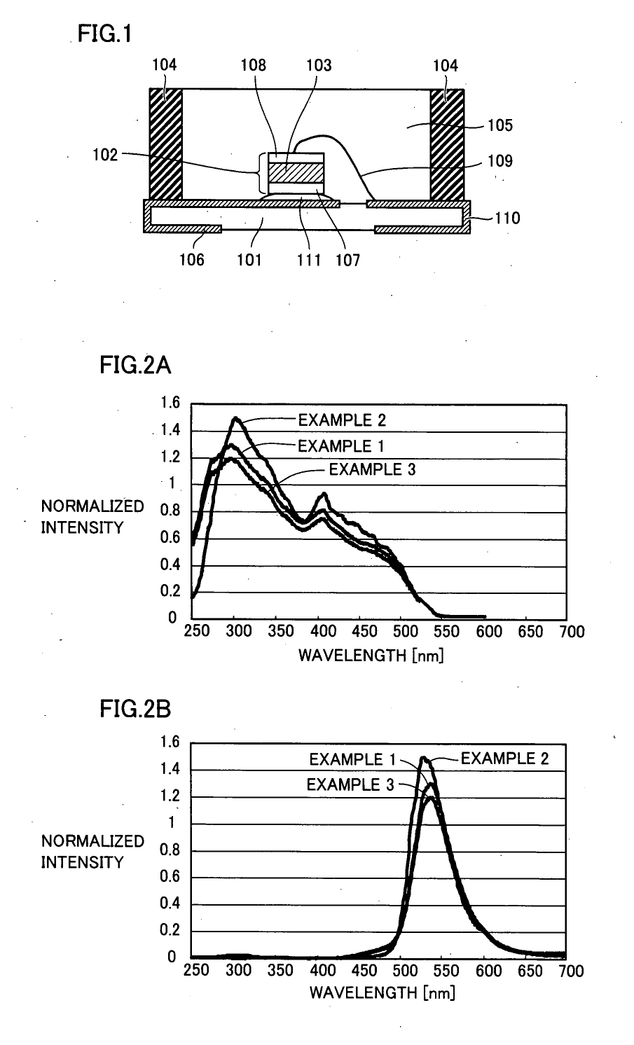

Si₃N₄ powder having an average particle diameter of 0.5 μm, an O content of 0.93 weight % and an α-type content of 92 weight %, AlN powder (TOYALITE-FLC by Toyo Aluminum K.K.) coated with SiO₂ having a specific surface area of 5.0 m²/g, an Si content of 0.65 weight % and an O content of 1.46 weight % and Eu₂O₃ powder of 99.9 weight % in purity were employed as raw metallic compound powder materials. The material ratios (weight %) of the raw metallic compound powder materials were 95.8% (47.9 g) of Si₃N₄, 3.4% (1.7 g) of AlN and 0.8% (0.4 g) of Eu₂O₃. These raw metallic compound powder materials were mixed with each other in a mortar and the mixture was charged into a crucible of BN, which in turn was introduced into a graphite electrical resistance furnace. The electric furnace was evacuated by a vacuum pump, and firing was performed by heating the mixture from the room temperature to 800° C. at a rate of 500° C. per hour, introducing nitrogen of 99.999 volume % in purity at 800° C. for setting the pressure to 1 MPa, raising the temperature to 1900° C. at the rate of 500° C. per hour and holding the mixture at 1900° C. for 8 hours. A phosphor obtained by this firing was pulverized into fine powder in a mortar of an Si₃N₄ sintered body. An X-ray diffraction pattern of the obtained phosphor powder with K-α rays was checked with an X-ray diffractometer by Rigaku Corporation, to recognize formation of β-sialon. This phosphor powder was irradiated with a lamp emitting light having a wavelength of 365 nm, to confirm green emission. The specific surface area of the phosphor powder measured by LEA-NURSE by Tsutsui Rikagaku Kogyo was 0.65 m²/g. FIGS. 2A and 2B show the absorption (excitation) spectrum and the emission spectrum of this phosphor powder measured with F-4500 by Hitachi, Ltd. respectively. FIG. 2A shows the absorption (excitation) spectrum, and FIG. 2B shows the emission spectrum. The absorption (excitation) spectrum was measured by scanning the intensity of 537 nm corresponding to the emission peak. The emission spectrum was measured when the phosphor powder was excited with light of 297 nm corresponding to the excitation peak. The ratio occupied by the β phase was 75 weight % from the X-ray diffraction intensity ratio, and the content of the metallic elements other than the optical active element, Si and Al measured by a CID-DCA emission spectroscope was 30 ppm.

### Example 2

A slurry was formed by mixing raw metallic compound powder materials equivalent to those in Example 1 with each other, introducing the mixture of 50 g in total weight into a ball-milling pot having an inner diameter of 100 mmφ along with 175 ml of ethanol, and rotating the pot with Si₃N₄ balls of 10 mmφ at a rotational speed of 60 rpm for 2 hours. The temperature was kept at 15 to 30° C. during this operation. Then, the obtained slurry was spray-dried at a spraying temperature of 100° C. to 200° C. and a nitrogen flow rate of 350 L/h., for obtaining 45.2 g of granules consisting of aggregates of the raw metallic compound powder materials. B-290 by Nihon Buchi K.K. was employed as the spray drier. FIG. 4 is an SEM photograph showing the granules formed in the aforementioned method in 1000 magnifications. It has been recognized from the SEM photograph of FIG. 4 that the average particle diameter of the granules is not more than 50 μm. Then, the obtained granules were introduced into a crucible of BN, and fired in a graphite electrical resistance furnace under conditions equivalent to those in Example 1. The specific surface area of the obtained phosphor powder was 0.39 m²/g. FIGS. 2A and 2B also show the absorption (excitation) spectrum and the emission spectrum of this phosphor powder respectively, similarly to Example 1. The absorption (excitation) spectrum was measured by scanning the intensity of 529 nm corresponding to the emission peak. The emission spectrum was measured when the phosphor powder was excited with light of 302 nm corresponding to the excitation peak. The ratio occupied by the β phase was 80 weight %, and the content of the metallic elements other than the optical active element, Si and Al was 20 ppm.

### Example 3

Si₃N₄ powder having an average particle diameter of 0.5 μm, an O content of 0.93 weight % and an α-type content of 92 weight %, AlN powder having a specific surface area of 3.3 m²/g and an O content of 0.79 weight % and Eu₂O₃ powder of 99.9 weight % in purity were employed as raw metallic compound powder materials. Then, 50 g of the aforementioned Si₃N₄ powder was dispersed into 100 ml of an ethanol solvent along with 0.7 g of SiO₂ powder having a particle diameter of 30 nm for forming a slurry, which in turn was spray-dried at a spraying temperature of 150° to 200° C. and a nitrogen flow rate of 450 L/h. so that the surface of the Si₃N₄ powder was coated with the SiO₂ powder. Then, the coated Si₃N₄ powder, AlN and Eu₂O₃ were mixed with each other in a mortar in mixing ratios (weight %) of 95.8% (47.9 g), 3.4% (1.7 g) and 0.8% (0.4 g), and the mixture was charged into a crucible of BN, to be fired in graphite electrical resistance furnace under conditions equivalent to those in Examples 1 and 2. The specific surface area of the obtained phosphor powder was 0.75 m²/g. FIGS. 2A and 2B also show the absorption (excitation) spectrum and the emission spectrum of this phosphor powder respectively, similarly to Example 1. The absorption (excitation) spectrum was measured by scanning the intensity of 537 nm corresponding to the emission peak. The emission spectrum was measured when the phosphor powder was excited with light of 297 nm corresponding to the excitation peak. The ratio occupied by the β phase was 70 weight %, and the content of the metallic elements other than the optical active element, Si and Al was 27 ppm.

### Comparative Example 1

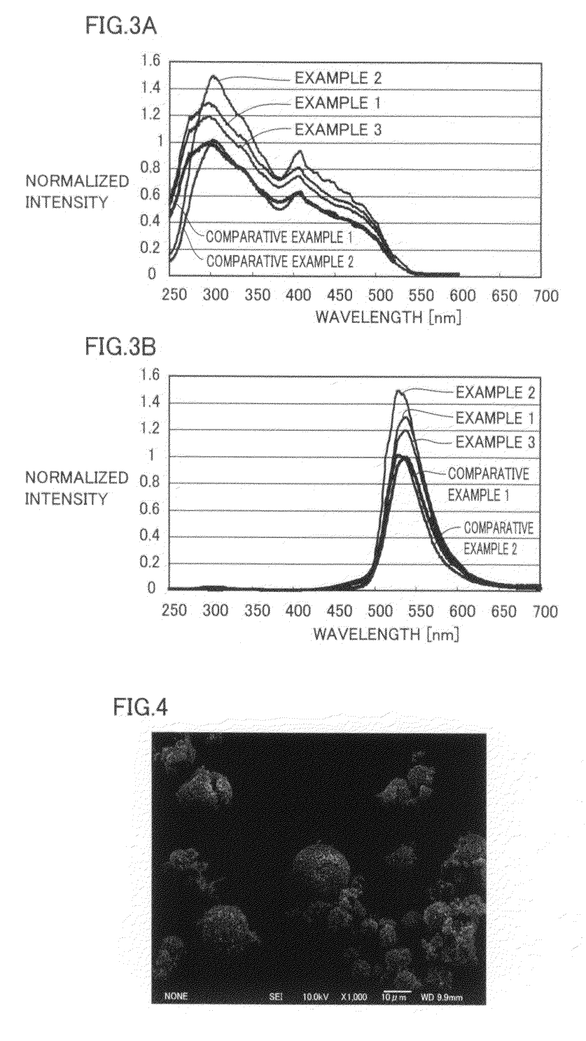

Si₃N₄ powder having an average particle diameter of 0.5 μm, an O content of 0.93 weight % and an α-type content of 92 weight %, AlN powder having a specific surface area of 3.3 m²/g and an O content of 0.79 weight % and Eu₂O₃ powder of 99.9 weight % in purity were employed as raw metallic compound powder materials, which in turn were mixed with each other and fired under conditions similar to those in Example 1. The specific surface area of the obtained phosphor powder was 1.15 m²/g. FIGS. 3A and 3B show the absorption (excitation) spectrum and the emission spectrum of this phosphor powder respectively. The absorption (excitation) spectrum was measured by scanning the intensity of 537 nm corresponding to the emission peak. The emission spectrum was measured when the phosphor powder was excited with light of 297 nm corresponding to the excitation peak. The ratio occupied by the β phase was 65 weight %, and the content of the metallic elements other than the optical active element, Si and Al was 120 ppm.

### Comparative Example 2

A slurry was formed by mixing raw metallic compound powder materials equivalent to those in comparative example 1 with each other, introducing 50 g in total weight of the obtained mixture into a ball-milling pot having an inner diameter of 100 mm along with 175 ml of ethanol, and rotating the pot with Si₃N₄ balls of 10 mmφ at a rotational speed of 60 rpm for 2 hours. The temperature was kept at 15 to 30° C. during this operation. Then, the obtained slurry was spray-dried at a spraying temperature of 100° C. to 200° C. and a nitrogen flow rate of 350 L/h. for obtaining 44.0 g of granules consisting of aggregates of the raw metallic compound powder materials. B-290 by Nihon Buchi K.K. was employed as the spray drier. Then, the obtained granules were introduced into a crucible of BN, and fired in a graphite electrical resistance furnace under conditions similar to those in Example 1. The specific surface area of the obtained phosphor powder was 1.12 m²/g. FIGS. 3A and 3B also show the absorption (excitation) spectrum and the emission spectrum of this phosphor powder respectively. The absorption (excitation) spectrum was measured by scanning the intensity of 529 nm corresponding to the emission peak. The emission spectrum was measured when the phosphor powder was excited with light of 302 nm corresponding to the excitation peak. The ratio occupied by the β phase was 67 weight %, and the content of the metallic elements other than the optical active element, Si and Al was 132 ppm.

It is understood from FIGS. 3A and 3B that the phosphors according to comparative examples 1 and 2 are lower in luminous intensity as compared with the phosphors according to Examples 1 to 3. More specifically, the phosphors according to Examples 1, 2 and 3 exhibit fluorescence intensity levels of about 1.3, about 1.5 and about 1.2 respectively with reference to the fluorescence intensity of the phosphor according to comparative example 1. This means that the phosphors according to Examples 1 to 3 were improved in reaction in firing, to result in the increased luminous intensity levels.

It is also understood from the aforementioned results that the phosphor according to Example 2 has higher luminous intensity as compared with those according to Examples 1 and 3. This means that the reaction was further prompted due to the granulation of the mixture of the raw metallic compound powder materials by spray drying in advance of the firing, to result in the increased luminous intensity.

### (Preparation of Semiconductor Light-Emitting Device)

### Examples 4 to 6

Mixtures of phosphors emitting white light were prepared by mixing the Eu-activated β-sialon phosphors obtained according to the aforementioned Examples 1 to 3, Ce-activated La₃Si₈N₁₁O₄ phosphors and Eu-activated CaAlSiN₃ phosphors with each other at weight ratios shown in Table 1 respectively. The β-sialon phosphors according to Examples 1, 2 and 3 were employed for Examples 4, 5 and 6 respectively. Each of the obtained mixtures of the phosphors was dispersed into silicone resin employed as optically transparent resin so that the weight ratio between silicon resin and the phosphor was 100 g/15 g, for preparing a semiconductor light-emitting device similar to that shown in FIG. 1. A semiconductor light-emitting element having a peak emission wavelength of 405 nm was employed for this semiconductor light-emitting device.

### Comparative Examples 3 and 4

Semiconductor light-emitting devices were prepared from mixtures of phosphors similar in composition to Example 4, except that the β-sialon phosphors according to comparative examples 1 and 2 were employed respectively. The β-sialon phosphors according to comparative examples 1 and 2 were employed for comparative examples 3 and 4 respectively, and mixed with other materials at weight ratios shown in Table 1.

### Examples 7 to 9

Semiconductor light-emitting devices similar to that shown in FIG. 1 were prepared similarly to Examples 4 to 6, except that the Eu-activated β-sialon phosphors according to Examples 1 to 3 were mixed with the aforementioned Eu-activated CaAlSiN₃ phosphors at weight ratios shown in Table 1 and semiconductor light-emitting elements having peak emission wavelengths of 450 nm were employed. The β-sialon phosphors according to Examples 1, 2 and 3 were employed for Examples 7, 8 and 9 respectively. The weight ratio between silicon resin and each phosphor was set to 100 g 7 g.

### Comparative Examples 5 and 6

Semiconductor light-emitting devices were prepared by mixing phosphors similar in composition to Example 7 with other materials at weight ratios shown in Table 1 except that the β-sialon phosphors according to comparative examples 1 and 2 were employed. The β-sialon phosphors according to comparative examples 1 and 2 were employed for comparative examples 5 and 6 respectively.

Table 1 shows CIE coordinates and luminous intensity levels of the semiconductor light-emitting devices according to Examples 4 to 9 and comparative examples 3 to 6. The luminous intensity levels were measured by a combination of Silicon Photodiode S9219 and Photosensor Amplifier C9329 by Hamamatsu Photonics K.K. with a driving current of 20 mA. The CIE coordinates are indices showing colors of emitted light, and the coordinates (x, y)=(0.33, 0.33) show white. The CIE coordinates were measured with MCPD-7000 by Otsuka Electronics Co., Ltd. at a driving current of 20 mA, similarly to the luminous intensity levels. It is understood from Table 1 that the semiconductor light-emitting devices according to Examples 4 to 9 emitted white light having higher luminous intensity levels as compared with those according to comparative examples 3 to 6. This resulted from the employment of the β-sialon phosphors according to the present invention. Comparing the semiconductor light-emitting devices according to Examples 4 and 7 and those according to Examples 5 and 8 with each other, it is understood that the semiconductor light-emitting devices according to Examples 5 and 8 exhibited higher luminous intensity levels. This means that that the reaction in the firing was further prompted due to the granulation of the unfired metallic compound powder materials in advance of the firing in each of Examples 5 and 8, to result in the phosphors having high luminous efficiency.

TABLE 1

| | | | | Luminous |
|---|---|---|---|---|
| | | | | Intensity |
| | Used Phosphor | Weight Ratio | CIE Coordinates | (mcd) |
| Example 4 | Ce-activated La3Si8N11O4 | 24 | (0.332, 0.335) | 750 |
| | Eu-activated β-sialon | 2.7 | | |
| | Eu-activated CaAlSiN3 | 1 | | |
| Example 5 | Ce-activated La3Si8N11O4 | 24 | (0.329, 0.327) | 870 |
| | Eu-activated β-sialon | 2.5 | | |
| | Eu-activated CaAlSiN3 | 1 | | |
| Example 6 | Ce-activated La3Si8N11O4 | 24 | (0.330, 0.333) | 720 |
| | Eu-activated β-sialon | 2.8 | | |
| | Eu-activated CaAlSiN3 | 1 | (0.333, 0.340) | 1280 |
| Example 7 | Eu-activated β-sialon | 5.5 | | |
| | Eu-activated CaAlSiN3 | 1 | | |
| Example 8 | Eu-activated β-sialon | 4.5 | (0.328, 0.325) | 1480 |
| | Eu-activated CaAlSiN3 | 1 | | |
| Example 9 | Eu-activated γ-sialon | 6 | (0.331, 0.335) | 1210 |
| | Eu-activated CaAlSiN3 | 1 | | |
| Comparative | Ce-activated La3Si8N11O4 | 24 | (0.330, 0.33 1) | 620 |
| Example 3 | Eu-activated β-sialon | 3 | | |
| | Eu-activated CaAlSiN3 | 1 | | |
| Comparative | Ce-activated La3Si8N11O4 | 24 | (0.331, 0.332) | 630 |
| Example 4 | Eu-activated β-sialon | 3 | | |
| | Eu-activated CaAlSiN3 | 1 | | |
| Comparative | Eu-activated β-sialon | 7 | (0.330, 0.330) | 1030 |
| Example 5 | Eu-activated CaAlSiN3 | 1 | | |
| Comparative | Eu-activated β-sialon | 7 | (0.331, 0.334) | 1035 |
| Example 6 | Eu-activated CaAlSiN3 | 1 | | |

### (Preparation of Image Display)

### Example 10

An image display having a structure shown in FIG. 5 was prepared. FIG. 5 is a schematic diagram showing an exemplary image display according to the present invention. Referring to FIG. 5, the image display has a GaN-based semiconductor laser 501 serving as an excitation light source and a screen 508 consisting of a large number of pixels comprising the phosphors according to the present invention. A modulator 502 modulates a laser beam emitted from semiconductor laser 501, and an electrooptic deflector 503 corrects pitch irregularity of a raster. Thereafter a wobbling galvanometer 504 and a vertical deflection galvanometer 505 perform vertical scanning. Thereafter relay lenses 506 transmit and condense the laser beam, a rotating polygon mirror 507 performs horizontal scanning, and two-dimensional scanning is performed on screen 508 consisting of the large number of pixels comprising the phosphors according to the present invention with the intensity-modulated laser beam, so that screen 508 displays an image. The Eu-activated β-sialon phosphors, the Eu-activated CaAlSiN₃ phosphors and the Ce-activated La₃Si₈N₁₁O₄ phosphors used in Examples 4 to 6 were employed as phosphors in this Example, while semiconductor laser 501 was formed by a device having a peak emission wavelength of 405 nm.

### Example 11

An image display similar in structure to that according to Example 10 was prepared except that the Eu-activated β-sialon phosphors and the Eu-activated CaAlSiN₃ phosphors used in Examples 7 to 9 were employed as phosphors and a semiconductor laser 501 having a peak emission wavelength of 450 nm was employed.

### Example 12

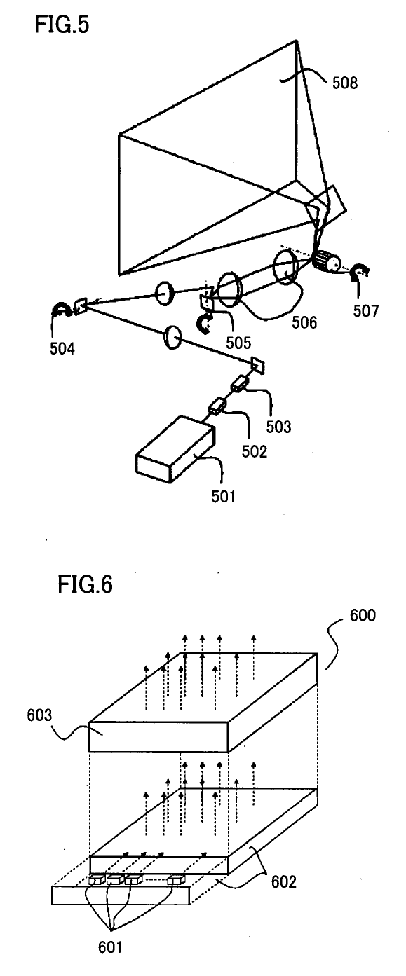

An image display 600 having a structure shown in FIG. 6 was prepared. FIG. 6 is a schematic diagram showing another exemplary image display according to the present invention. Image display 600 shown in FIG. 6 is a liquid crystal display having a light source 601 formed by the semiconductor light-emitting device according to Example 5, a light guide 602 guiding light received from light source 601 and a liquid crystal panel 603 including a color filter separating the light received from light guide 602 into spectral components.

### Example 13

A liquid crystal display similar in structure to that according to Example 12 was prepared except that a light source 601 was formed by the semiconductor light-emitting device according to Example 8.

Although the present invention has been described and illustrated in detail, it is clearly understood that the same is by way of illustration and example only and is not to be taken by way of limitation, the scope of the present invention being interpreted by the terms of the appended claims.

1. A β-sialon phosphor containing an optical active element M, having a specific surface area of not more than 0.8 m²/g measured by the air permeation method.

2. The β-sialon phosphor according to claim 1, wherein
said specific surface area is not more than 0.4 m²/g.

3. The β-sialon phosphor according to claim 1, wherein
the ratio occupied by a P phase in the crystal phase is at least 70 weight %, and the content of a metallic element other than said optical active element M, Si and Al is not more than 100 ppm in weight ratio.

4. The β-sialon phosphor according to claim 3, wherein
the ratio occupied by a P phase in the crystal phase is at least 90 weight %.

5. A method of preparing a β-sialon phosphor containing an optical active element M, including a firing step of firing a mixture containing metallic compound powder, wherein
said mixture contains:
(A) metallic compound powder containing said optical active element M, and
(B) metallic compound powder coated with a compound, forming a liquid phase at a temperature lower than a firing temperature, containing at least one element selected from Si and Al.

6. The method of preparing a β-sialon phosphor according to claim 5, wherein
said mixture further contains (C) at least one material selected from metallic compound powder consisting of Si₃N₄ and metallic compound powder consisting of AlN.

7. The method of preparing a β-sialon phosphor according to claim 5, wherein
said metallic compound powder in (B) is at least one material selected from metallic compound powder consisting of Si₃N₄ and metallic compound powder consisting of AlN.

8. The method of preparing a β-sialon phosphor according to claim 5, wherein
said optical active element M is at least one element selected from a group consisting of Mn, Ce, Pr, Nd, Sm, Eu, Tb, Dy, Ho, Er, Tm and Yb.

9. The method of preparing a β-sialon phosphor according to claim 8, wherein
said optical active element M is Eu.

10. The method of preparing a β-sialon phosphor according to claim 5, wherein
said compound, forming a liquid phase at a temperature lower than said firing temperature, containing at least one element selected from Si and Al is an oxide.

11. The method of preparing a β-sialon phosphor according to claim 10, wherein
said compound, forming a liquid phase at a temperature lower than said firing temperature, containing at least one element selected from Si and Al is SiO₂.

12. The method of preparing a β-sialon phosphor according to claim 5, shaping said mixture containing said metallic compound powder into granules consisting of aggregates of said powder and thereafter firing said granules in said firing step.

13. The method of preparing a β-sialon phosphor according to claim 12, shaping said granules by spray-drying a slurry containing said mixture containing metallic compound powder and a solvent.

14. The method of preparing a β-sialon phosphor according to claim 5, having a coating step of preparing said (B) metallic compound powder coated with a compound, forming a liquid phase at a temperature lower than said firing temperature, containing at least one element selected from Si and Al, in advance of said firing step.

15. The method of preparing a β-sialon phosphor according to claim 14, wherein
said coating step includes a spray-drying step of spray-drying a slurry containing said metallic compound powder to be coated, said compound, forming a liquid phase at a temperature lower than said firing temperature, containing at least one element selected from Si and Al and a solvent.

16. A β-sialon phosphor containing the optical active element M prepared by the method according to claim 5.

17. A semiconductor light-emitting device at least having:
a semiconductor light-emitting element; and
a phosphor excited by light emitted from said semiconductor light-emitting element, wherein
at least one said phosphor is the β-sialon phosphor according to claim 5.

18. The semiconductor light-emitting device according to claim 17, wherein
said semiconductor light-emitting element has an InGaN layer as an active layer.

19. The semiconductor light-emitting device according to claim 17, wherein
said semiconductor light-emitting element has a peak emission wavelength in the range of 350 to 430 nm.

20. The semiconductor light-emitting device according to claim 19, wherein
said phosphor further contains at least one phosphor selected from a group consisting of a Ce-activated La₃Si₈N₁₁O₄ phosphor or solid solution and an Eu-activated CaAlSiN₃ phosphor.

21. The semiconductor light-emitting device according to claim 17, wherein
said semiconductor light-emitting element has a peak emission wavelength in the range of 430 to 480 nm.

22. The semiconductor light-emitting device according to claim 21, wherein
said phosphor further contains an Eu-activated CaAlSiN₃ phosphor.

23. An image display employing the semiconductor light-emitting device according to claim 17.

24. The image display according to claim 23, which is a liquid crystal display employing the semiconductor light-emitting device as a backlight source.
